(19) United States
(12) Patent Application Publication
(10) Pub. No.: US 2009/0182677 A1
(43) Pub. Date: Jul. 16, 2009

(54) Upsell system embedded in a system and controlled by a third party

(76) Inventors: Jonathan Otto, Palm Beach, FL (US); Raymond J. Mueller, Palm Beach Gardens, FL (US); Michael R. Mueller, San Francisco, CA (US); Andrew Van Luchene, Santa Fe, NM (US)

Correspondence Address: SIMPSON & SIMPSON, PLLC, 5555 MAIN STREET, WILLIAMSVILLE, NY, 14221-5406, US

(21) Appl. No.: 11/985,141

(22) Filed: Nov. 14, 2007

(51) Int. Cl. G06Q 30/00; G06Q 10/00

(52) U.S. Cl. 705/80; 705/30; 705/26; 705/14

(57) ABSTRACT

A method of determining compensation, including the steps of: generating, using a processor of a specially programmed general-purpose computer and a first software program stored in a memory element of the general-purpose computer and offered by a first business entity, at least one sales offer; transmitting the at least one sales offer using an interface element for the general-purpose computer; tracking, using the processor and a second software program stored in the memory element and supplied by a third business entity, the at least one sales offer and respective acceptances of sales offers from the at least one sales offer, the respective acceptances received by the interface element; determining, using the processor and the second software program, revenue from the respective acceptances; and calculating, using the processor and the second software program, compensation for use of the product or service, based on the revenue.

### CROSS-REFERENCE TO RELATED APPLICATIONS

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### FIELD OF THE INVENTION

The invention relates generally to methods and systems for determining compensating for an entity providing a product or service to another entity based on the performance of the product or service with respect to predetermined criteria. In particular, the invention determines incremental revenue associated with the use of the product or service as a means of determining the compensation.

### BACKGROUND OF THE INVENTION

Many automated systems promise to save money, increase revenues, or otherwise increase profitability of an entity. Many existing methods are used by software and other vendors to charge for products and software applications provided by these vendors. A common method is to charge a license fee for use of a software application. For example, Microsoft charges a certain fee for each copy of the Vista operating system. Such fees may be included in the cost of a equipment using the software, such as a laptop, or fees may vary based upon discriminating factors, such as price differences for students and teachers and a discounted price for users upgrading software from a previous version of the software.

In addition, certain vendors, especially those that provide services via the World Wide Web, offer services using the so called ASP or Application Service Provider. Many of these and other vendors provide access to such services on a “pay as you go” basis or based upon a fixed or variable monthly fee. Unfortunately, none of the preceding methods provides the end user with an option to pay based upon the actual performance of such applications.

Thus, there is a long-felt need to provide a system and method for providing a product, application, or service in which the fee for the use of the product, application, or service would be based on the actual performance of the product, application, or service or on actual results obtained from the use of the product, application, or service.

### SUMMARY OF THE INVENTION

The present invention broadly comprises a method of determining compensation, including the steps of: generating, using a processor of a specially programmed general-purpose computer and a first software program stored in a memory element of the general-purpose computer and provided by a first business entity, at least one sales offer for a second business entity; transmitting the at least one sales offer using an interface element for the general-purpose computer; tracking, using the processor and a second software program stored in the memory element and provided by a third business entity, the plurality of sales offers and respective acceptances of sales offers from the at least one sales offer, wherein the respective acceptances are received by the interface element; determining, using the processor and the second software program, revenue from the respective acceptances; and calculating, using the processor and the second software program, compensation for use of the first software program, based on the revenue.

In one embodiment, determining revenue includes determining, using the second software program, incremental revenue from the respective responses attributable to the use of the first software program, and calculating compensation includes calculating the compensation at least partly with respect to the incremental revenue. In one embodiment, the first and second software applications are a single software application. In one embodiment, the first and third business entities are a single business entity.

In one embodiment, wherein generating at least one sales offer includes generating respective base portions and upsell portions for the at least one sales offer, tracking the at least one sales offer and respective acceptances of sales offers includes tracking respective acceptances of the respective base portions and upsell portions, determining incremental revenue from the respective responses includes determining revenue due to the respective acceptances of the upsell portions, and calculating the compensation at least partly with respect to the incremental revenue includes calculating compensation based at least partly on the revenue due to the respective acceptances of the upsell portions.

The present invention also broadly comprises a method of determining compensation for use of a software application, including the steps of: generating at least a portion of a retail offer for a first business entity using a processor of a specially programmed general-purpose computer and a first software application stored in a memory element of the general-purpose computer and provided by a second business entity; transmitting the retail offer using an interface element for the general-purpose computer; determining, using the processor and a second software application stored in the memory element and provided by a third business entity, incremental revenue associated with a response to the retail offer, the response received by the interface element and the incremental revenue attributable to the use of the first software application to generate the retail offer; and calculating, using the processor and the second software application, compensation to the second business entity for use of the first software application by the first business entity, based at least partly on the incremental revenue.

In one embodiment, generating at least a portion of a retail offer includes generating a base portion of the retail offer and an upsell portion of the retail offer, determining incremental income includes tracking, using the processor, an acceptance of the base portion and the upsell portion, and calculating compensation includes calculating compensation based on the acceptance of the upsell portion. In one embodiment, the first and second software applications are a single software application or the second and third business entities are a single business entity.

The present invention further broadly comprises a method of determining compensation for use of a software application, including the steps of: generating a base portion of a retail offer and an upsell portion of the retail offer for a first business entity using a processor of a specially programmed general-purpose computer and a first software application in a memory element of the general-purpose computer, the first software application provided by a second business entity; transmitting the retail offer using an interface element for the general-purpose computer; tracking, using the processor and a second software application stored in the memory element and provided by a third business entity, an acceptance of the base portion and the upsell portion, the acceptance received by the interface element; and calculating, using the processor and the second software application, compensation for the second business entity for use of the first software application by the first business entity, based on the acceptance of the upsell portion.

In one embodiment, the first and second software applications are a single software application or the second and third business entities are a single business entity. In one embodiment, generating an upsell portion includes generating an incentive to accept the upsell portion. In one embodiment, the incentive is a discount.

The present invention also broadly comprises a system for determining compensation and a system of determining compensation for use of a software application.

It is a general object of the present invention to provide systems and methods in which payment for use of a product, application, or service is based on the actual performance or benefits obtained from the product, application, or service.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic block diagram of a present invention system for determining compensation;

FIG. 2 is a flow chart depicting a present invention method for determining compensation;

FIG. 3 is a flow chart depicting a present invention method for determining compensation for use of a software application; and,

FIG. 4 is a flow chart depicting a present invention method for determining compensation for use of a software application.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

The following non-limiting definitions are applicable to the present invention:

Business—includes any business enterprise formed for the purpose of providing a product or service, which may or may not be for profit.

Business objective—includes any desired outcome of a business or business owner, including, for example, acquisition of new customers, delivery of one or more marketing offers, increases or improvements in product quality or service, sales, profits, customer counts, customer visitation frequency, customer loyalty, average check, average item counts, order contents, speed of service measurements, labor rates, sales per labor hour, year over year or same store sales, percentage market share, annual or periodic growth rates, employee or management retention or turnover rate, inventory control or turns, inventory waste, raw or finished waste, increases in stock prices, improved return on assets or equity, or any other objective as determined by management or other authorized individual or as established by rules or other metrics including or stored in a system designed for such purposes.

Business Information—includes any information that is provided, known, gathered, assumed or is otherwise determined or stored that is related to or is about or otherwise helps understand, define, operate, improve, track or report the performance of, a business, for example, customer acquisition and sales data, marketing information, click-through rates, conversion rates, profit and loss information, accounting information, financial information, statistics and ratios, customer information, sponsor information, information about any one or more business, customer or sponsor objectives, or any other information, business metrics and data gathered or stored or otherwise possessed or accessible by a business and/or any of its affiliates, sponsors, customers or investors.

Controller—means any one or more of the following electronic devices including, but not limited to: cell phones, Personal Digital Assistants or (PDA's), Blackberry or similar devices, such as hand held computers, MP3 players, or any other personal electronic device that has one or more of a keyboard, speaker, microphone, one or more buttons, or any other similar devices that provides a User with Input and/or Output Functionality and Remote Connectivity. A Controller may be or include one or more of a Display and/or a Server or other computing devices or means of computing.

Customer Facing Display—includes any device accessible by an end user or customer that includes at least one of a display, input means, e.g., a touch screen or keyboard, or other output means, e.g., a speaker. In certain embodiments, a Customer Facing Display may include a Kiosk, POS Terminal, or other computing device, such as a cell phone, PDA, laptop or PC. In certain embodiments a customer facing display may be a POS or POS terminal and vice versa.

Customer Identifier—includes, but is not limited to a cell phone, an RFID tag, a credit card, a debit card, a frequent shopper card or number, a coupon, a license plate, a check, a loyalty or gift card, fingerprint or other biometric input, a driver's license, or other identification means.

Customer Information—includes any information that is provided, known, gathered, assumed or is otherwise determined or stored that is related to or is about or otherwise helps understand or define a customer and/or a customer's buying habits, preferences or tendencies. Such information may include the customer's (or any related person, e.g., a child) order history, order contents, ideal order acceptance or rejection data, willingness to accept or reject one or more marketing offers or messages (either specific or types or categories of offers), price point or price elasticity, tendency to attempt to game other otherwise attempt to take advantage of the system or marketing program, average order total, e.g., average check, average item count, e.g., average number of items in a given order, average customer count, e.g., how many persons in the party on average, any demographic information, e.g., income, race, mailing address, zip codes, phone numbers, household total income, number of children, age, sex, number and type of internet enabled devices, participation in one or more marketing programs, willingness to use kiosks, cell phones or other ordering devices, prior ordering history, including willingness or tendency to accept pre, mid and/or post order marketing offers, e.g., suggestive selling, cross selling, sponsor rewards, or any other offers, and/or any other information gathered or provided by/from the customer, e.g., preferences information gathered by observing such customer behavior, e.g., does customer switch from cold beverages to hot beverages in the wintertime, and/or information gathered or supplied by a marketing program and/or by such customer when signing up or otherwise maintaining such information in a customer loyalty or other marketing program's database, or by importing or otherwise accessing information about such customer via any public or commercially accessible database and/or any combination of the foregoing information.

Customer Objective—includes any desired outcome, behavior that benefits a customer, including, for example, improved or better pricing, service, e.g., friendly service, speed of service, accuracy of service, quality of delivered products, types of marketing offers and/or savings associated with each, cleanliness of location, type of online or other ordering systems, including, e.g., POS devices, or any other favorable treatment or benefit that can be obtain or otherwise accrues to the benefit of such customer, and/or any combination of the foregoing.

Dilution—includes any outcome that has a net negative effect, e.g., an acceptance of an upsell or other offer results in providing a discount on an item, which a customer might otherwise have paid full price.

Discount—includes any price or offer at an amount other than the standard list price or expected price or shelf price, or displayed price, e.g., online.

Display—includes any one or more of the following electronic devices including, but not limited to: TV (of any technology type, including but not limited to a Plasma Display, LCD, CRT or DLP), Kiosk, LED display, Electronic Shelf Label, Automated Teller Machine (ATM), POS terminal, video game display, video slot machine or other video based casino games, speaker, or any other device capable of displaying, presenting or otherwise outputting or processing Output Materials (such as an LCD or other display in an airline seatback or other Location, e.g., a grocery cart equipped with a display and/or a bar code or RFID printer or reader), including devices that provide a User with Output Functionality. A Display may include or be one or more of a Controller and/or a Server and/or other computing device capable of providing Input and/or Output Functionality and/or Remote Connectivity.

Domain Name Server (DNS)—One or more computers including a cooperatively run set of databases, distributed among several servers, volunteered as repositories for IP address information.

End User—includes any person or entity making use of any one or more of the methods of the disclosed invention, and/or any system that uses or is based upon or benefits from one or more of the disclosed inventions, including, for example, customers, vendors, retailers, QSR operators, managers, employees, supervisors, friends, family members, or any other person as applicable to the given context or otherwise.

Existing Member—includes a member of a loyalty program or other marketing program and/or a person that has signed up for any marketing or other program and/or has provided information to such a program, whether or not such person is aware of such program, including, end users.

Frequent Shopper Program—includes any system that provides one or more rewards to members of such program for purchases made.

Frequency Program—includes any Frequent Shopper Program or other rewards system that rewards customers for their frequency of visit and/or buying one or more products, goods or services.

GUI—includes a graphical user interface, or other means of providing communications from or to an end user, including via graphics, text, audio, video, data input, such as voice, typing, touch screen, or other means of input or output to/from any device, including a POS Terminal, or other computing devices. Such GUI may include information and/or actions that are available for viewing, use or interaction with an end user. Such interaction may be accomplished via any applicable means, including, for example, manipulating icons, widgets or other items or areas displayed on such GUI, including, clicking on one or more hyperlinks, and/or entering information into fields or other areas designed for such purposes, e.g., typing a name, or selecting one or more items from a displayed list, etc.

Header—A numeric code assigned to a request for content by either a LAN or ISP Server, which identifies a requestor's unique Internet Protocol Address. Generally, the Header is used for purposes of accurately returning a requested Mark-up Language-based electronic document as well as any corresponding files to the requestor.

Hyperlink—A text phrase or graphic embedded within a markup language-based electronic file, which corresponds to the address of a site on the World Wide Web.

Input Functionality—includes any one or more of any of the following, including but is not limited to any device that includes or provides one or more buttons (e.g., a keyboard) that can convey individual or grouped electrical signals, impulses, commands, or messages, or other tactile or other input device including a joy stick, mouse, touch screen, and/or audio (e.g., voice commands or instructions), bar code scanner, RFID reader, fingerprint or other biometric scanning device, scale, laser pointer, camera, infrared sensor, cell phone, hand held computer or PDA keypad, motion or other “presence” detector, magnetic card or magnetic card reader, and any other input method recognizable by or able to convey information to any one or more of a Display, Server, Controller or other computing device.

Internet—includes the world wide web and the network that is accessible by the public that includes a network of interconnected computers that transmit data using, for example, Internet Protocol (IP). In some aspects, certain private networks, including virtual private networks (VPN) may be included in the definition of the Internet.

Internet Device or Internet Enabled Device—includes any computing device that is capable of accessing or otherwise communicating with or via the Internet or any other network, client/server and/or peer-to-peer or any other network, and/or that is otherwise able to practice or benefit from any one or more of the herein disclosed inventions.

Internet Ordering or Online Purchase—includes the processing, in whole or in part, of any one or more transactions using or otherwise communicating via the Internet or other means of communications by or between any one or more of a business, sponsor and/or one or more customers, which transaction may be for or include the purchase, trade or acquisition of one or more items. In certain embodiments, internet ordering or online purchases may include the delivery of one or more marketing messages or marketing offers.

Item—includes any object, tangible or intangible, which may include any item for sale, rental, lease, consumption, transfer, and/or may be possessed or owned. Item may include any physical or virtual object. In certain embodiments an item may be any one or more of a food item, a beverage item, a dessert item, a retail good, a food product, a device, a POS device, a coupon, clothing, furnishings, groceries, automobiles, motorcycles, lighting, electrical equipment or devices, etc.

Kiosk—includes any device or location that permits a customer or end user to enter part or all of an order and/or respond to a marketing message or offer, with or without the assistance of a third party, e.g., a cashier. Kiosks may include software to prevent end users from performing unauthorized actions and/or accessing the system, operating system or other secure areas of the kiosk and/or systems to which it may be attached or connected, e.g., the Internet or one or more servers, etc.

Location—means and includes, but is not limited to retail stores, restaurants, bars, theme parks, casinos, video game parlors, Internet Cafe's, coffee bars, book stores, gas stations, convenience stores, hotel rooms, hotel or other lobbies, meeting rooms, office buildings, offices, airports, airplanes, government or other public services buildings, hospitals or any other public or private area or facility or residence that contains, possesses or otherwise provides limited or general access to at least one Display and/or practices part or all of any one or more embodiments of the present invention.

Loyalty or Frequent Shopper Member—includes any end user or person that has joined or signed up or opted into a loyalty program and/or frequent shopper program.

Loyalty Member—a person that has signed up for or otherwise participates in a loyalty or frequent shopper program.

Loyalty Program—any system that permits users to sign up to receive rewards based upon such user's purchases or visitation frequency.

Marketing Message—Includes a marketing offer, or any other communication with an end user, e.g., a customer, which message may include any one or more of the following such as, any one or more of a graphic, logo, icon, price, discount or other offer, video, audio, or other visual, audio or static marketing or other content designed to communicate with or otherwise inform, educate or persuade a User. In certain embodiments, a marketing message may include one or more marketing offers.

Marketing Offer or Offer—includes any offer for sale of any item, good, product or service.

Marketing Program—includes any system that provides marketing messages, marketing content, loyalty programs, coupons, discounts, or any other offers or marketing offers, and/or tracks customer buying habits and other information, including customer information, such as locations, travels, demographics, ordering preferences, etc.

Markup Language—A set of codes in a text file that instructs a computer how to format the file for purposes of printing and/or display, as well as how to index and link the content of the file. Example markup languages include HTML, SGML, XML, VRML, and NRML.

Network Device—includes any device that can be interfaced with a technology network, for example, the Internet, a wireless communications network, (e.g., a cellular telephone system), a LAN, or a WAN.

Optimized—includes determining which marketing offer will likely or generally achieve the desired results or maximum results among or given one or more of several complimentary or competing objectives, including, for example, sales volume, gross margin, profits, customer accept rates, average check, speed of service times, product quality, freshness, customer satisfaction, customer frequency, order point, destination point or any other variables that affect or are of interest to one or more affected parties, e.g., the retail establishment, its suppliers and/or the customer. In certain embodiments, optimized includes finding the maxima or minima of a given function. In certain embodiments, the terms optimized and optimal have corollary meanings.

Output functionality—includes transmission of information via Remote Connectivity and/or conveying Output Materials on a Display and/or tactile feedback.

Output Materials means any one or more of the following, including but is not limited to any one or more of, Marketing Messages, audio, still images and/or video, flash and/or other animated sequences or materials, printed or visual reports or receipts, displayed information, information recorded to or stored on a hard drive or other computer readable medium, a text message, voice mail message, a sound such as a beep or bell or buzzer, audio messages (e.g. a voice prompt or marketing message or other information), including recorded, actual or synthetic voice messages, or any other output generated by a Display, Server, Controller, Network or other device or application that is sent to or processed by a User, Display, Server, Controller, Network or other device for subsequent viewing, listening and/or further processing or storage.

PC—includes a personal computer, such as a laptop, such as one provided by Dell Computers.

PDA—includes a personal digital assistant, such as Palm Pilot, or any other personal computing device, which includes at least one of a display, processor, memory or input or output means.

Point of Sale—includes any Point of Sale system or device that permits an end user to start, enter or complete an order or sales transaction, such as Panasonic's 7900 “all in one”, or any other POS devices, terminals or systems, websites, kiosks, PCs, PDAs, Cell Phones, call centers, slot machines, vending machines, and/or any other Internet or other device that provides access to any of the functionality or inventions disclosed herein and or any of the same or similar functionality and/or otherwise permits an end user to practice or benefit from any of the disclosed inventions. Point of Sale and POS shall have corollary meanings.

POS Device, includes a POS or other physical device that provides access to any of the features or inventions disclosed herein and or any of the same or similar functionality and/or otherwise permits an end user to practice or benefit from any of the disclosed inventions.

POS Terminal—includes a POS or other physical device that provides access to any of the foregoing and or any of the same or similar functionality and/or otherwise permits an end user to practice or benefit from any of the disclosed inventions.

Product—includes any machine, manufacture and/or composition of matter, unless expressly specified otherwise.

Prospective Member—includes any person that is not currently a member.

Referral—includes any prospective member identified or otherwise provided by an existing member.

Proximal, Proximity, Proximal/Proximity Data—includes any information about an end user's current or predicted whereabouts. Such information may include distance, i.e., distance between two points, e.g., a retail location and the end user, which distance may be measured directly, e.g., point A to point B, or based upon travel means, e.g., based upon the streets or other paths that a person or end user could actually use to travel from said point A to said point B, and/or may be based upon time, e.g., how long it might take a given end user to travel said distance between point A and point B, perhaps further as determined by such end user's current rate of travel or average rate of travel or method of travel, etc. Methods to calculate distances between to points in space and/or to estimate travel time are well known by those of ordinary skill in the art.

Response—includes any action and/or failure to act by any person. For example, a response from a prospective member includes the immediate or subsequent reply to or use of one or more marketing messages or offers or other response, which response includes, but is not limited to, for example, signing up to one or more loyalty, frequency or other marketing programs, acceptance and/or use, e.g., redemption, of any one or more offers or coupon, opting in to one or more loyalty, frequency or other marketing program(s), achieving or maintaining a certain level of sales and/or number or frequency of store visits, purchases of certain products, providing one or more email addresses, visiting one or more retail, restaurant or other store location(s), ordering one or more items, or specific items, or failure to order one or more items or specific items, filling out a form or forms, or providing additional information, such as mailing address, phone number, internet device id information, and/or signing up for one or more third party sponsor programs, and/or any other action as determined or established by the marketing program, pressing one or more buttons and/or clicking on one or more hyperlinks or any combination of the foregoing. The terms response and respond shall have corollary meanings.

Reports—in certain of the disclosed embodiments, one or more reports may be developed to provide tracking and/or analysis relating to any one or more data elements associated with any such embodiment or invention. Reports include any feedback or communication requested by or delivered to one or more end users, which may or may not require authorization to receive such report. Reports can be printed, verbalized using a text to speech conversion program, or displayed on any device, including, for example, a POS terminal or other computing device. Such reports may be created and/or delivered using any applicable means available. The methods to create and deliver reports are well understood and known within the industry and are disclosed in the prior art. Reports may be demand request, i.e., a report is generated only when or as requested, or exception based, i.e., a report is generated if a certain condition or conditions are met, not met or change in any defined way. In certain embodiments, reports are generated whenever desired or otherwise indicated or scheduled, and may be stored for subsequent use, which use may or may not be based on a request by an end user. Reports may include any one or more available database elements and/or calculated results based upon any one or more of the databases, database elements, mathematical or statistical manipulations, and/or any of the methods disclosed herein and/or as understood by any person skilled in the art and/or as requested/designed by one or more end users or other authorized personnel. For example, a report may include any one or more pieces of information contained or relating to customer, business or sponsor information, and/or POS transaction data and/or any or all results information generated or associated with any marketing offer or message.

Reward—includes any item or object or incentive that is or might be of benefit to its recipient, for example, a free or discounted item or a financial incentive, presented to an end user, e.g., an existing loyalty or marketing program member. In certain embodiments, rewards may be provided without any action of or by the recipient to receive such reward. In other embodiments, recipients must perform certain actions, e.g., purchase items from a business, or make a commitment to make such purchases, in order to receive, earn or otherwise qualify for any such reward(s). In some embodiments, a reward may be cash or an offer of cash or other financial currency or benefit. In certain embodiments, a reward may be an item, such as a toy, or a coupon. In yet other embodiments, a reward may be a combination of any or all of the foregoing. In certain embodiments, rewards may be created, funded or otherwise provided by businesses or sponsors. Rewards may be offered and/or delivered using any applicable means, including electronic transmission via the Internet, cell phones, text or voice mail, and may include one or more marketing messages or marketing offers. Rewards may be issued, granted or provided by individuals or groups and/or delivered or provided to individuals or groups. In certain embodiments, recipients of one or more rewards may be required to perform a certain task or tasks to qualify and/or to make use of one or more rewards. In some embodiments, rewards may be used only by the specific individual(s) who received the reward. In addition or in the alternate, rewards may be transferable or do not specify the recipient or require that only the recipient may benefit from such reward(s). In some embodiments a coupon may be a reward and/or a reward may be a coupon.

Viral Reward—includes any reward, coupon or other incentive designed to encourage additional use of such reward and/or to encourage one or more additional persons to join a loyalty or marketing program and/or to help achieve any other business, sponsor or customer objective(s). In some embodiments, viral rewards may be communicated via any applicable means, including, for example, via email, voice mail or text based messaging services. The terms viral reward, network reward, viral coupon, and network coupon shall have corollary meanings.

RFID—includes a radio frequency identification tag, transponder or similar devices.

Router—An intermediary device within a communications network that expedites message delivery. Within a single network linking many computers through several possible connections, a router receives transmitted messages and forwards them to their correct destination via an efficient available route.

Sensor—includes any application or device that can make a determination or otherwise detecting the change, presence or absence of something, including, for example, temperature, weight, sound, pressure, volume, mass, light, odors, and/or any recording, or registration, change, presence or absence of or to any data or other electronic media. In certain embodiments a sensor includes one or more transducers.

Sponsor—includes any third party or entity that provides product, goods or services and/or money or other financial means to an end user or retail entity in exchange for the option to communicate with such end user, including, for example, to provide one or more marketing messages or offers, including, e.g., a cross sell offer or sponsor reward.

Store—includes any one or more retail, restaurant or other location, and may include online locations, websites, kiosks, automated stores, e.g., vending machines, so called “brick and mortar” locations, and/or any combination of the foregoing, and/or access to any such location(s) using any POS device.

Sponsor information—includes any information that is provided, known, gathered, assumed or is otherwise determined or stored that is related to or is about or otherwise helps understand, define, operate, improve, track or report the performance of, a sponsor business, for example, customer acquisition and sales data, marketing information, click-through rates, conversion rates, profit and loss information, accounting information, financial information, statistics and ratios, customer information, sponsor information, information about any one or more sponsor objectives, or any other information, business metrics and data and/or business information gathered or stored or otherwise possessed or accessible by a sponsor and/or any of its affiliates, businesses, customers or investors.

Sponsor objective—includes any desired outcome of a sponsor or sponsor business owner, including, for example, acquisition of new customers, conversion of competitor's customers to sponsor's customers, delivery of one or more marketing messages or offers, increases or improvements in sales, profits, customer counts, customer visitation frequency, customer loyalty, average check, average item counts, order contents, speed of service measurements, labor rates, sales per labor hour, year over year or same store sales, percentage market share, annual or periodic growth rates, employee or management retention or turnover rate, inventory control or turns, inventory waste, raw or finished waste, increases in stock prices, improved return on assets or equity, or any other objective as determined by management or other authorized individual or as established by rules or other metrics including or stored in a system designed for such purposes.

Subscription—includes an agreement, which may be implicit or explicit, to purchase a certain quantity of goods, services, products or items and/or purchase the rights to use or access such goods, services, products or items, during or over a specified period of time, and/or an agreement to spend a certain amount of money over a certain period. In certain embodiments, subscriptions may be accepted through an action or failure to act by a subscriber or end user. In certain embodiments, subscriptions may automatically renew based upon an action or inaction of a subscriber or end user. In certain embodiments, a virtual subscription may be accomplished without formal agreement among the affected parties, e.g., by selling a razor that requires use of specific blades.

Tag—A code embedded within an markup language-based electronic file which associates one or more words or images within the document with a Uniform Resource Locator (URL) corresponding to another file. Within the art, a tag of this particular functionality may be referred to as an “HREF” (hypertext reference) tag.

Transaction—includes any communication or agreement between two or more entities, including end users, individuals, retailers, and/or computing systems. In certain embodiments a transaction can include a financial transaction wherein a seller sells and item and a buy buys an item, where such seller may experience an increase in finances while the buyer's finances may decrease. In certain embodiments, a transaction may include a communication between a computing system and an one or more end users, or between two computing systems, a computing system and a database or data repository, two end users, two or more data repositories, etc. In additional embodiments, a transaction includes a POS transaction, where a customer places and pays for one or more items, goods, services, or products and/or access to or use of any or all of the foregoing, and/or via a website and/or using a POS terminal or POS device.

Upsell—includes any offer to purchase one or more items at a full, discounted or other price including the retail price. Upsells include offers to increase an order size, quantity, type or contents of an entity's, e.g., a customer's order.

Upsell/Instruction/Commission Output device—includes, but is not limited to: a POS terminal, a website, a drive through or other digital menu board, a drive through speaker, a cell phone, telephone, pager or PDA, a kiosk, a vending machine, a customer counter display, an in-store or other digital menu board, a display built into a restaurant table, a vending machine, a speaker, or slot machine.

User—includes any entity or person including a person making use or practicing the various disclosed embodiments of the invention. The terms user and end user shall include corollary meanings.

User-Visible Text Portion—A portion of markup language-based code which specifies the text or other images to be displayed to a Web user. An example (in bold) as well as the corresponding tag (underlined) follows: Ex. <A HREF=“http://go.msn.com/npl/msnt.asp”target=“_top”><IMG SRC=“/chan/home/logo.gif” WIDTH=140 HEIGHT=60 BORDER=0ALT=“Go to msn.com”>Microsoft Network</A>

Web Browser—A client application that enables a user to view markup language-based documents on the World Wide Web, another network, or the user's computer; utilize the hyperlinks among the documents, as well as transfer and execute files within the documents.

Web Site—A subset of the World Wide Web comprising a collection of files, documents and graphics made generally available to others through the Internet. In certain embodiments a web site may include means for conducting a transaction, including, for example, a POS transaction.

Wireless Communications Device (WCD)—A communications device that transceives via a non-wired medium, such as radio frequency. A WCD can include, but is not limited to an AM or FM radio device, a television, cell phones, portable phones, and devices, such as laptop computers and PDAs interfaced with a wireless network, for example, a LAN. Applicable formats, standards or protocols, include Ethernet (or IEEE 802.3), SAP, ATP, Bluetooth, and TCP/IP, TDMA, CDMA, and 3G.

World Wide Web—The total set of inter-linked hypertext documents residing on Hypertext

Computing. It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. A “processor” means one or more microprocessors, central processing units (CPUs), computing devices, microcontrollers, digital signal processors, or like devices or any combination thereof.

A description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software or hardware only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

Remote Connectivity means any method used by a Controller, a Display or a Server or other computing devices to communicate with other devices or networks including, but not limited to the Internet, Satellite networks, Cell Phone networks, other wireless networks and standards such as 802.11, 80211.b, 802.11g, or similar wireless LAN operating standards, or Bluetooth technologies, infrared connections, or any other similar technologies or other technologies such as those described above that permit the sending and/or receiving and/or processing of electronic information in either an encrypted or unencrypted format.

Server means one or more computing systems that include at least one of a processor, computer readable medium, or input/output capabilities and may have local or Remote Connectivity capabilities. Servers may be local or remote to Displays or both. A Server may be or include one or more of a Display and/or a Controller.

In an embodiment, a Server computer or centralized authority may not be necessary or desirable. For example, the present invention may, in an embodiment, be practiced on one or more devices without a central authority. In such an embodiment, any functions described herein as performed by the Server computer or data described as stored on the Server computer may instead be performed by or stored on one or more such devices.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

“Determining” something can be performed in a variety of manners and therefore the term “determining” (and like terms) includes calculating, computing, deriving, looking up (e.g., in a table, database or data structure), ascertaining, recognizing, and the like. A “display” as that term is used herein is an area that conveys information to a viewer. The information may be dynamic, in which case, an LCD, LED, CRT, LDP, rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as standard definition (SDTV), enhanced definition (EDTV), high definition (HD), or the like. The information may likewise be static, in which case, painted glass may be used to form the display. Note that static information may be presented on a display capable of displaying dynamic information if desired.

The present disclosure may refer to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, CPU devices, computing devices, microcontrollers, digital signal processors, or like devices. Exemplary processors are the INTEL PENTIUM or AMD ATHLON processors. The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, TDMA, CDMA, GSM, EDGE, GPRS, WCDMA, AMPS, D-AMPS, IEEE 802.11 (WI-FI), IEEE 802.3, SAP, SAS™ by IGT, OASIS™ by Aristocrat Technologies, SDS by Bally Gaming and Systems, ATP, TCP/IP, gaming device standard (GDS) published by the Gaming Standards Association of Fremont Calif., the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The present disclosure provides, to one of ordinary skill in the art, an enabling description of several embodiments and/or inventions. Some of these embodiments and/or inventions may not be claimed in the present disclosure, but may nevertheless be claimed in one or more continuing applications that claim the benefit of priority of the present disclosure.

It will, of course, be understood that the foregoing description is of exemplary embodiments of the invention and that the invention is not limited to the specific embodiments shown. Various changes and modifications will become apparent to those skilled in the art and all such variations and modifications are intended to come within the spirit and scope of the appended claims.

In general, a present invention system for determining compensation includes a specially programmed, general-purpose computer with an interface element to send and receive, that is, transceive, data regarding sales activities undertaken by a business entity. At least a portion of the sales activities are originated using a generation element, function, or capability in a processor for the general-purpose computer and a service or product provided by another business entity or vendor. The processor also includes a tracking element, function, or capability that tracks the sales activities, a revenue element, function, or capability arranged to determine revenue from the sales activity due to the use of the product or service, and a compensation element, function, or capability arranged to calculate a compensation for the other entity or vendor based on guidelines, stored in a memory element, function, or capability of the general-purpose computer and described infra, and the revenue attributable to the product or service. In some aspects, the memory element, function, or capability is used to store ancillary information used b y the elements noted supra. In some aspects, the service or product is a software application stored in the memory element. Thus, for example, the system is able to determine compliance of the performance of product or service with respect to a predetermined parameter, or benchmark, and compensate the vendor accordingly. For example, if the product or service generates a certain volume of sales or gross profit, then a predetermined compensation is provided to the vendor.

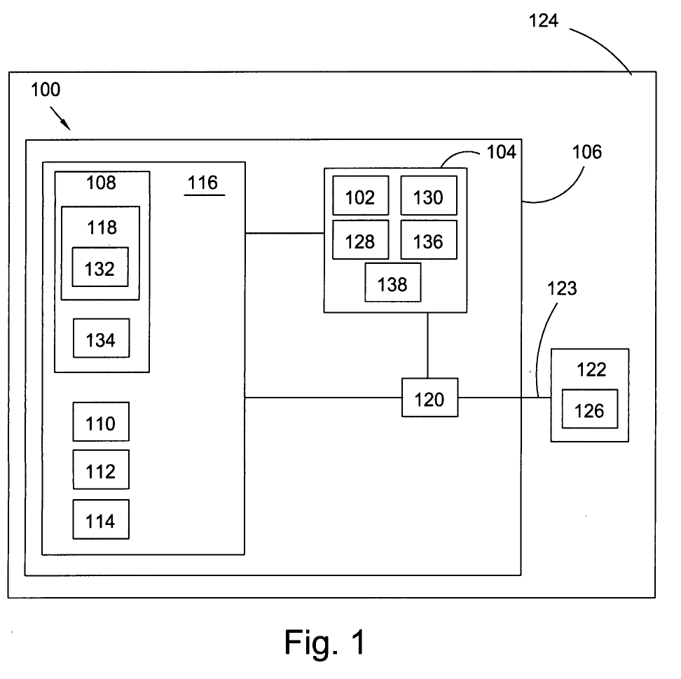

FIG. 1 is a schematic diagram of present invention system 100 for determining compensation for use of a product or service 102. In the discussion that follows, a software application 102 is used as an example of a product or service, however, it should be understood that a present invention system is not limited to use with a software application and that any product or service known in the art can be used with a present invention system. In some aspects, application 102 is stored in memory element 104 of specially programmed general-purpose computer 106. In some aspects (not shown), the application is stored in a different computer. Application 102 is provided to, supplied to, or offered to, an end user, or first business entity, (not shown) by a second business entity, or vendor (not shown). In general, the first business entity operates system 100. However, in one embodiment, the second business entity operates system 100. By operating system 100, we mean that a business entity owns or controls the larger business framework in which system 100 operates. The literal operation of system 100 can be by another party contracted by the end user. Any vending, provision, or supply procedure or arrangement known in the art can be used to provide application 102. In some aspects, the same vendor supplies system 100 and application 102.

System 100 also includes generating element 108, tracking element 110, revenue element, or determining element, 112, and compensation element, or calculating element, 114, each located in processor 116 of computer 106. Alternately stated, elements 108, 110, 112, and 114 are functions of the processor or are functions carried out by the processor. Element 108 is arranged to generate a plurality of retail offers 118 using application 102. As further described infra, application 102 can be used to generate all or a portion of offers 118 or to modify existing offers to create offers 118. Any retail offers known in the art can be generated. Computer 106 can be any computer or combination of computers known in the art. Processor 116 can be any processor known in the art. In one embodiment a retail offer is generated as disclosed by commonly-owned United States Patent Application labeled “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

Interface element 120 transmits offers 118 for presentation. Any presentation method, system, or device known in the art can be used. In some aspects, element 120 transmits the offers to network device 122. By interface element, we mean any combination of hardware, firmware, or software in a computer used to enable communication or data transfer between the computer and a device, system, or network external to the computer. The interface element can connect with the device, system, or network external to the computer using any means known in the art, including, but not limited to a hardwire connection, an optical connection, an Internet connection, or a radio frequency connection. In FIG. 1, hardwire connection 123 is shown. Interface element 120 can be any interface element known in the art. Device 122 can be any network device known in the art. In FIG. 1, for purposes of illustration, device 122 is a POS, having a GUI, in retail location 124. By retail location, we mean a location where goods are offered for sale to customers. Goods can be offered by any pricing structure known in the art, for example, goods can be offered at manufacturer's list prices available to the general public or can be offered at wholesale prices only available to prospective customers meeting certain requirements. Retail offers are further described infra.

Element 120 is arranged to receive responses 126 from device 122, in response to offers 118. Tracking element 110 is arranged to track responses using software application 128 stored in the memory element. Application 128 is supplied by, offered by, or provided by, a third business entity (not shown). In some aspects (not shown), application 128 is stored in a different computer. In one embodiment, the second and third business entities are the same. In one embodiment, applications 102 and 128 are a single application provided by a single business entity. That is, the functions described herein for applications 102 and 128 are performed by a single application. Thus, a potential customer (not shown) of the retail location responds to the offer on the GUI either by declining the offer, accepting portions of the offer, or accepting the entire offer, and element 110 keeps track of this response.

Revenue element 112 is arranged to determine, using program 128, revenue associated with the responses. In some aspects, as further described infra, the revenue is incremental revenue accrued via the response and due to the use of application 102. Compensation element 114 is arranged to calculate, using program 128, compensation 129 for the second business entity, from the first business entity, for use of application 102 by the first business entity, based on the revenue. In some aspects, element 112 also uses information 130, provided by an entity associated with the retail location and stored in the memory element, to determine the compensation. Information 130 is typically associated with the operation of location 124 and can include information such as overhead costs, material costs, labor costs, or sales history.

Thus, system 100 generates retail offers for a first business entity using a product or service, for example, software application 102, provided by a second business entity and calculates compensation for the second business entity for the use of the product or service using software application 128. Thus, system 100 determines a performance based compensation or fee payable by the first business entity to the second business entity.

Application 128 can include any means known in the art for calculating fees, including, but not limited to, statistical analysis, rules based table(s), or artificial intelligence elements, such as genetic algorithm(s). Application 128 typically defines and implements a predetermined structure or schedule negotiated between the first and second business entities, as further described infra. The structure or schedule can be static or dynamic.

In some aspects, the determining element is arranged to determine, using program 128, incremental revenue 131 from respective responses 126 attributable to the use of application 102. Then, the calculating element is arranged to calculate, using program 128, the compensation at least partly with respect to incremental revenue 131.

In some aspects, element 108 is arranged to generate base portions 132 of offers 118 and added portions 134 of the offers. In one embodiment, portions 134 are attributable to application 102 in system 100 and base portions 132 are associated with standard operation in location 124, that is, operation without the use of application 102. For example, portions 132 are existing or standard offers generated by the end user without the use of application 102 and portions 132 are added to the base portions by application 102. In some aspects, portions 134 are upsells associated with portions 132 or portions 134 are entirely new items. In some aspects, offers 118 only include portions 132, for example, offers 118 are upsells separately presented after a standard offer presented without the use of application 102.

Tracking element 110 is arranged to track respective acceptances of portions 132 and 134 and revenue element 112 identifies respective revenues associated with portions 132 and 134. For example, if the upsell noted above is accepted, element 112 identifies revenues associated with the upsell. Element 114 then calculates a fee associated with offer 118 and the various revenues identified above, in particular, factoring, or taking into account, revenue associated with portion 134. That is, system 100 provides a means of separating and quantifying revenues associated with existing operations and ‘enhanced’ operations, that is, operations associated with use of application 102 to generate or modify offers. Alternately stated, the compensation for the use of application 102 is only with respect to income that is generated above the “normal” operations (operations without the use of application 102) of the first business entity. For example, revenue associated with an upsell is only counted for compensation of the second business entity if the upsell results in an overall increase in the revenue. That is, system 100 only pays a commission for revenue generated from software module 102 that is over and above the revenue the first business entity was generating before the use of the software module. In one embodiment, element 110 tracks performance for the first business entry using application 102 against data for performance of the first business entry in a time period before the use of application 102, for example, for a time period when base offers without upsells were presented by the first business entity.

As an example, if the first business entity is a restaurant that had an average check of $4.82 in December of a particular year, and in December of the following year, with the use of application 102, the same restaurant had an average check of $5.34, then application 128 would calculate compensation for the second business entity based on the differential of 52 cents per check. Such a calculation is different from calculating compensation purely on the revenue generated from the portion of the sale due to use of application 102, for example, due to an upsell. Continuing the example above, the average revenue increase due to the upsell alone is 78 cents, but as noted above, the average check only increased by 52 cents. Thus, the 26 cent difference would be considered dilutive (for example, the upsell may have included discounts) and would not be used to calculate compensation. In one embodiment, the preceding approach is applied to profits. Continuing the above example, the average check of $4.82 generated 96 cents in profit and the average check of $5.34 generated $1.11 in profit. Then, the compensation for the second business entity would be based on the increase of 15 cents profit per check.

As noted supra, in one embodiment, applications 102 and 128 are provided by the same entity (the second and third business entities are the same). For example, RetailDNA's (RDNA's) Point of Marketing (POM) system (not shown) is an example of application 102 in system 100 and RDNA also can provide application 128. The POM system is used to generate offers 118 in a retail location with the goal of increasing the volume and incremental revenue associated with the offers. Advantageously, through the use of system 100, RDNA can extend to the end user a fee structure for use of the POM system based on an increase in sales, or incremental revenue, due to use of the POM system. For example, a user is not charged for use of the POM system for transactions that do not generate incremental revenue due to the POM system. For example, using system 100, RDNA can offer a fee structure for use of POM to end users for a percentage share of the increase in revenues. In should be understood that the fee structure can be determined using any applicable means or combination of means known in the art, including, but not limited to: a percentage of the additional revenues generated by one or more of the POM modules; a base rental or license or use fee, plus a percentage of the additional revenues; gross sales, incremental sales only; gross margin, incremental gross margin only; incremental net profits; increases in customer count, average check, category sales, specific item sales, and/or any other revenue or expense line item.

In some embodiments, application 102 includes multiple modules in a licensed software program and system 100 tracks base and incremental sales to determine the effectiveness of the licensed software, for individual modules and/or collectively. In some embodiments, application 102 provides automated suggestive selling, for example, via RDNA's Visual Deal O application and system 100 tracks customer buying habits system to evaluate the relative successfulness of various offers 118, for example, which offers are accepted more often, and thereby determine which offers may yield better incremental or accretive sales increases. For example, element 104 can be configured to store appropriate rules-based tables and/or genetic algorithms 136, offer element 108 can be configured to determine offers 118, and tracking element 110 can be configured to assess the effectiveness of the offers, for example, as disclosed by commonly-owned U.S. patent application labeled “METHOD AND SYSTEM FOR GENERATING, SELECTING, AND RUNNING EXECUTABLES IN A BUSINESS SYSTEM UTILIZING A COMBINATION OF USER DEFINED RULES AND ARTIFICIAL INTELLIGENCE,” inventors Otto et al., filed Nov. 9, 2007.

In one embodiment, system 100 tracks customer activities and the success and/or failure of offers 118 generated by application 102 in terms of customer acceptance and/or rejections to determine base and total sales associated with the offers. By including information from data 130, such as cost of sales, e.g., food and paper, and other operating profit and loss information, e.g., percentage rents, system 100 can accurately track and distinguish which sales and profits are due to an end user's existing operations. As well system 100 can accurately track and distinguish sales and profits generated by or otherwise due to the use of application 102, for example, licensed applications such as Visual Deal or POM.

In some embodiments, system 100 determines a periodic fee based on the total increases in revenues and/or profits or any other predetermined measure. System 100 can include a multiplicity of schemes for tracking and charging periodic fees. For example, the fee can be based on a fixed percentage of the predetermined measure, a variable percentage of the predetermined measure, or a combination of fixed and variable percentages. The fee also can be a combination of fixed fees and percentage-based fees, for example, a fee could be based upon a fixed dollar amount of $50 per month, plus 3% of incremental gross sales or $100 per month, plus 10% of incremental net profits.

In some embodiments, system 100 provides for a mixed licensing model, wherein certain licensing or access or use rights are based upon existing licensing models, e.g., fixed, variable, or ASP based, while certain other applications and/or benefits derived from such other applications, use, licensing, access, etc., may be based, in whole or in part, upon a Performance Based License Fee (PBLF) or a mixed model. For example, a customer may choose to license RDNA's POM “preorder” marketing module for $20 per month, while opting to license RDNA's Visual Deal, via a PBLF, for example, by paying 5% of net gross profits.

In some embodiments, system 100 is arranged so that the end user can add controls 138 in element 104, regarding the generation and presentation of offers. Then, element 108 can access the controls to generate offer 118. Such controls can include, but are not limited to, operating criteria, for example, linking offers to predetermined gross or net profit margins, randomness or any other criteria known in the art to determine what type offers are made, to which customers offers are presented, timing for the presentation of offers, and pricing of offers. Accordingly, the fee for using application 102 can be linked to the performance of system 100 with respect to expectations associated with the controls and operating criteria. For example, a full fee could be charged for performance above the expectations and a partial fee or no fee could be charged for performance below the expectations. For example, a quick service restaurant (QSR) operator using system 100 could set up a rule that instructs the system to sell products to ensure a minimum of 70% gross margin. The license agreement (the fee paid for use of application 102) could then be negotiated such that the end user pays a fee of 5% of any gross incremental sales when and only if such sales are at a 70% or better gross margin. Such agreement may further designate or indicate what fees, if any, shall be paid if such gross margin falls below 70%, e.g., the rate might be 3% for any incremental sales that have a gross margin less than 70% but greater than 60%, and 2% for any incremental sales that have a gross margin of greater than 50% but less than 60%, and no fees are to be paid on any sales that have less than 50% gross margin. As another example, system 100 can be configured, using any applicable means, including, for example, rules or table based restrictions, to preclude any offer for sale of any item, good or service that would result in a gross margin less than an end user specified amount, e.g., 60%.

Thus, system 100 provides a performance based licensing fee or model usable by a plethora of application vendors. Further, system provides great flexibility in the implementation of the fee or model. For example, system 100 can accommodate any structure known in the art that suits the business model/objectives of the end user and the actual or perceived benefits of any such system or applications for the end user. Such a performance based licensing model permits end users to implement a present invention system with little or no capital investment, and then, pay for such usage if and only if such system(s) actually perform as advertised or promised.

The above performance based arrangement eases the decision of the end user regarding the implementation of a present invention system and helps to ensure that the provider or vendor of a present invention system remains motivated as to the continued operability of such a system, the overall success of such a system, and the customer's satisfaction with such a system. For example, since the vendor supplying application 102 receives payment only when the performance of system 100 complies with predetermined criteria and/or is otherwise successful, the vendor is highly motivated to ensure that application 102 is working properly. For example, if RDNA provides application 102, such as POM, and RDNA only receives payments if application 102 is producing incremental revenue, RDNA is more likely to continue to provide its customers with periodic software updates and improved marketing materials to enhance the performance of application 102. Further, since the vendor and the end user each have a vested interest in increasing sales and profits, each are more likely to work together to identify problems within the system and/or its implementation, for example, in a QSR location, the use of a POS implementing application 102, by respective cashiers. For example, the vendor may be willing to reinvest more of its revenues back into the application and/or marketing materials and/or training of end users, e.g., cashiers, as the future of the vendor depends in whole or in part upon the success of its applications and the success of the end users, e.g., QSR or other retail operators.

It should be understood that a present invention system can be used by a wide variety of vendors or providers of products or services to determine performance based fee structures for the use of the products and services. For example, a vendor for a POS terminal could offer incentives, such as reduced up-front costs, in exchange for a fee structure based on the use of system 100 to monitor activities of the POS terminal. For example, for a nominal up-front fee, an end user could agreement to pay the POS vendor a percentage of the end user's sales or incremental sales and/or profits or incremental profits and/or based upon any other performance based measurement criteria as described supra. In this fashion, end users can obtain new, updated or expanded products or services with minimal capital investment. In fact, end users that would otherwise be unable to avail themselves of the products or services may be able to do so due to the use of system 100. Further, use of a present invention system may enable the vendor to increase market share, since the use of a present invention system enables the vendor to provide competitively priced solution, for example, due to minimized up-front costs, which solutions may include any one or more or all of the hardware, software, installation, training, services, maintenance or any combination of the foregoing. Vendors not able or willing to provide such options may find it increasingly difficult to compete against other vendors using a present invention system.

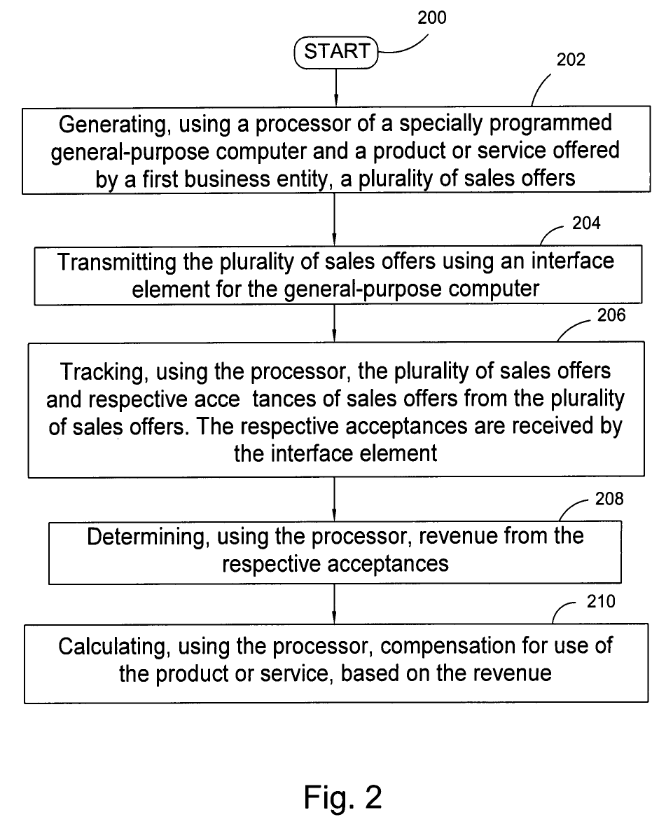

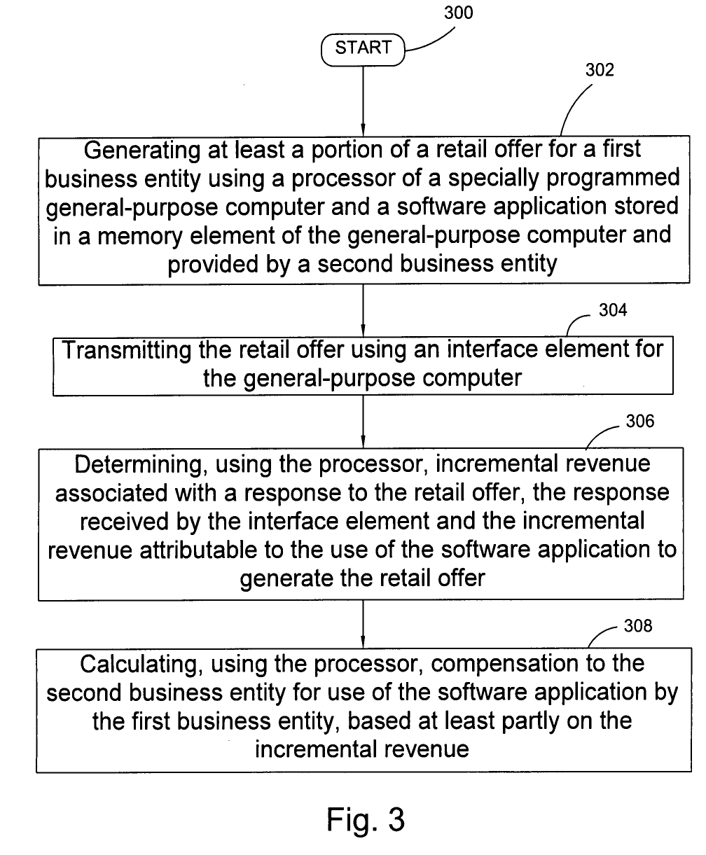

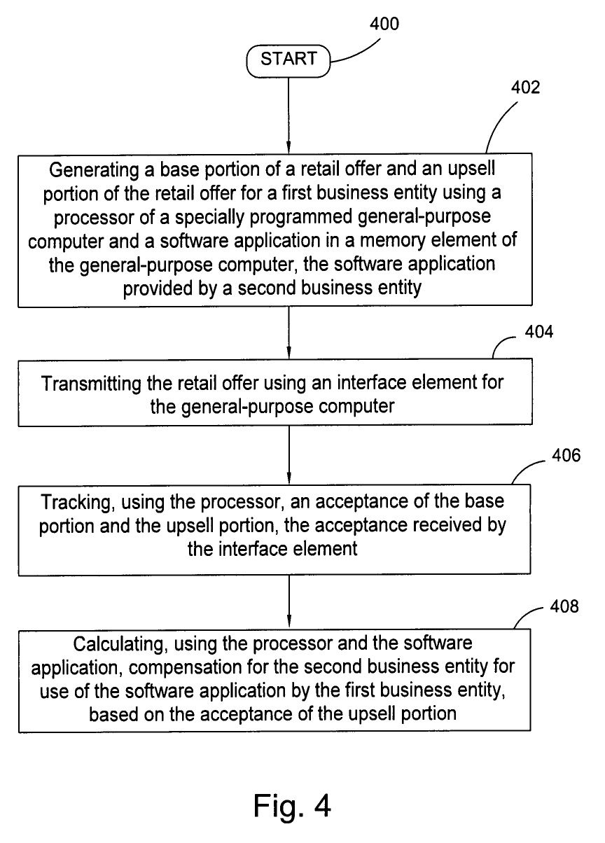

FIG. 2 is a flow chart illustrating a present invention method of determining compensation. Although the method in FIG. 2 (and FIGS. 3 and 4 below) is depicted as a sequence of numbered steps for clarity, no order should be inferred from the numbering unless explicitly stated. The method starts at Step 200. Step 202 generates, using a processor of a specially programmed general-purpose computer and a first software program stored in a memory element of the computer and offered by a first business entity, a plurality of sales offers for a second business entity. Step 204 transmits the plurality of sales offers using an interface element for the general-purpose computer. Step 206 tracks, using the processor and a second software program stored in the memory element and supplied by a third business entity, the plurality of sales offers and respective acceptances of sales offers from the plurality of sales offers. The respective acceptances are received by the interface element. Step 208 determines, using the processor and the second software program, revenue from the respective acceptances. Step 210 calculates, using the processor and the second software program, compensation for use of the first software program, based on the revenue.

In one embodiment, determining revenue includes determining incremental revenue from the respective responses attributable to the use of the product or service, and calculating compensation includes calculating the compensation at least partly with respect to the incremental revenue. In one embodiment, generating a plurality of sales offers includes generating respective base portions and upsell portions for the sales offers, tracking the plurality of sales offers and respective acceptances of sales offers includes tracking respective acceptances of the respective base portions and upsell portions, determining incremental revenue from the respective responses includes determining revenue due to the respective acceptances of the upsell portions, and calculating the compensation at least partly with respect to the incremental revenue includes calculating compensation based at least partly on the revenue due to the respective acceptances of the upsell portions.

In one embodiment, the first and second software applications are a single software application. In one embodiment, the first and third business entities are a single business entity.

FIG. 3 is a flow chart illustrating a present invention method of determining compensation for use of a software application. The method starts at Step 300. Step 302 generates at least a portion of a retail offer for a first business entity using a processor of a specially programmed general-purpose computer and a first software application stored in a memory element of the general-purpose computer and provided by a second business entity. Step 304 transmits the retail offer using an interface element for the general-purpose computer. Step 306 determines, using the processor and a second software program stored in the memory element and offered by a third business entity, incremental revenue associated with a response to the retail offer, the response received by the interface element and the incremental revenue attributable to the use of the first software application to generate the retail offer. Step 308 calculates, using the processor and the second software program, compensation to the second business entity for use of the software application by the first business entity, based at least partly on the incremental revenue.

In one embodiment, generating at least a portion of a retail offer includes generating a base portion of the retail offer and an upsell portion of the retail offer, determining incremental income includes tracking, using the processor, an acceptance of the base portion and the upsell portion, and calculating compensation includes calculating compensation based on the acceptance of the upsell portion. In one embodiment, the first and second software applications are a single software application or the second and third business entities are a single business entity.

FIG. 4 is a flow chart illustrating a present invention method of determining compensation for use of a software application. The method starts at Step 400. Step 402 generates a base portion of a retail offer and an upsell portion of the retail offer for a first business entity using a processor of a specially programmed general-purpose computer and a first software application stored in a memory element of the general-purpose computer and supplied by a second business entity. Step 404 transmits the retail offer using an interface element for the general-purpose computer. Step 406 tracks, using the processor and a second software program stored in the memory element and offered by a third business entity, an acceptance of the base portion and the upsell portion, the acceptance received by the interface element. Step 408 calculates, using the processor and the second software application, compensation for the second business entity for use of the software application by the first business entity, based on the acceptance of the upsell portion. In one embodiment, the first and second software applications are a single software application or the second and third business entities are a single business entity. In one embodiment, generating an upsell portion includes generating an incentive to accept the upsell portion. In one embodiment, the incentive is a discount.

The following is a listing of exemplary data bases that can be used in a present invention method or system. It should be understood that a present invention method or system is not limited to any or all of the databases shown and that other databases are included in the spirit and scope of the claimed invention.

Item Database: ID; Descriptor; Cost; Offer rules 1−n; and Price 1−n.

Transaction Database: ID; Items 1−n; Offer 1−n; Accepted Y/N 1−n; Order Total; and Taxes.

Profit and Loss Database: Time period start; Time period finish; Total Revenue; Total Profit; Module Revenue 1−n; and Module Profit 1−n.

Commission Database (lays out the commission structure for various performance metrics): Commission ID; Commission type; Performance Metics ID; and Commission amount.

Commission Due Database: Time Period; Commission ID 1−N; and Commission Due 1−n.

The following is a listing of exemplary performance metrics that can be used in a present invention method or system. It should be understood that a present invention method or system is not limited to any or all of the performance metrics shown and that other performance metrics are included in the spirit and scope of the claimed invention. Performance Metrics (used to measure performance, for example, profits, revenues, profits over last year): ID; Descriptor; and Performance rules.

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

What is claimed is:

1. A method of determining compensation, comprising the steps of:
generating, using a processor of a specially programmed general-purpose computer and a first software program stored in a memory element of the general-purpose computer and provided by a first business entity, at least one sales offer for a second business entity;
transmitting said at least one sales offer using an interface element for said general-purpose computer;
tracking, using said processor and a second software program stored in the memory element and provided by a third business entity, said plurality of sales offers and respective acceptances of sales offers from said at least one sales offer, wherein said respective acceptances are received by said interface element;
determining, using said processor and the second software program, revenue from said respective acceptances; and,
calculating, using said processor and said second software program, compensation for use of said first software program, based on said revenue.

2. The method of claim 1 wherein determining revenue further comprises determining, using the second software program, incremental revenue from said respective responses attributable to said use of said first software program, and wherein calculating compensation further comprises calculating said compensation at least partly with respect to said incremental revenue.

3. The method of claim 2 wherein generating at least one sales offer further comprises generating respective base portions and upsell portions for said at least one sales offer, wherein tracking said at least one sales offer and respective acceptances of sales offers further comprises tracking respective acceptances of said respective base portions and upsell portions, wherein determining incremental revenue from said respective responses further comprises determining revenue due to said respective acceptances of said upsell portions, and wherein calculating said compensation at least partly with respect to said incremental revenue further comprises calculating compensation based at least partly on said revenue due to said respective acceptances of said upsell portions.

4. The method of claim 1 wherein the first and second software applications are a single software application.

5. The method of claim 1 wherein the first and third business entities are a single business entity.

6. A method of determining compensation for use of a software application, comprising the steps of:
generating at least a portion of a retail offer for a first business entity using a processor of a specially programmed general-purpose computer and a first software application stored in a memory element of said general-purpose computer and provided by a second business entity;
transmitting said retail offer using an interface element for said general-purpose computer;
determining, using said processor and a second software application stored in the memory element and provided by a third business entity, incremental revenue associated with a response to said retail offer, said response received by said interface element and said incremental revenue attributable to said use of said first software application to generate said retail offer; and,
calculating, using said processor and said second software application, compensation to said second business entity for use of said first software application by said first business entity, based at least partly on said incremental revenue.

7. The method of claim 6 wherein generating at least a portion of a retail offer further comprises generating a base portion of said retail offer and an upsell portion of said retail offer, wherein determining incremental income further comprises tracking, using said processor, an acceptance of said base portion and said upsell portion, and wherein calculating compensation further comprises calculating compensation based on said acceptance of said upsell portion.

8. The method of claim 6 wherein the first and second software applications are a single software application or the second and third business entities are a single business entity.

9. A method of determining compensation for use of a software application, comprising the steps of:
generating a base portion of a retail offer and an upsell portion of said retail offer for a first business entity using a processor of a specially programmed general-purpose computer and a first software application in a memory element of said general-purpose computer, said first software application provided by a second business entity;
transmitting said retail offer using an interface element for said general-purpose computer;
tracking, using said processor and a second software application stored in the memory element and provided by a third business entity, an acceptance of said base portion and said upsell portion, said acceptance received by said interface element; and,
calculating, using said processor and said second software application, compensation for said second business entity for use of said first software application by said first business entity, based on said acceptance of said upsell portion.

10. The method of claim 9 wherein the first and second software applications are a single software application or the second and third business entities are a single business entity.

11. The method of claim 9 wherein generating an upsell portion further comprises generating an incentive to accept said upsell portion.

12. The method of claim 11 wherein said incentive is a discount.

13. A system for determining compensation, comprising:
a generating element, in a processor of a specially programmed general-purpose computer, arranged to generate, using a first software application offered by a first business entity, at least one sales offer for a second business entity;
an interface element for said general-purpose computer arranged to transmit said at least one sales offer;
a tracking element in said processor arranged to track said at least one sales offer and respective acceptances of sales offers from said at least one sales offer using a second software program supplied by a third business entity and stored in the memory element, wherein said respective acceptances are received by said interface element;
a determining element in said processor arranged to determine, using the second software program, revenue from said respective acceptances; and,
a calculating element in said processor arranged to calculate, using the second software program, compensation to said second business entity for use of said first software program, based on said revenue.

14. The system of claim 13 wherein said determining element is arranged to determine incremental revenue from said respective responses attributable to said use of said software application, and wherein said calculating element is arranged to calculate said compensation at least partly with respect to said incremental revenue.

15. The system of claim 14 wherein said generating element is arranged to generate respective base portions and upsell portions for said at least one sales offer, wherein said tracking element is arranged to track respective acceptances of said respective base portions and upsell portions, wherein said determining element is arranged to determine revenue due to said respective acceptances of said upsell portions, and wherein said calculating element is arranged to calculate compensation based at least partly on said revenue due to said respective acceptances of said upsell portions.

16. The system of claim 13 wherein the first and second software applications are a single software application.

17. The system of claim 13 wherein the first and third business entities are a single business entity.

18. A system of determining compensation for use of a software application, comprising:
a generating element in a processor of a specially programmed general-purpose computer arranged to generate at least a portion of a retail offer for a first business entity using a first software application stored in a memory element of said general-purpose computer and offered by a second business entity;
an interface element for said general-purpose computer arranged to transmit said retail offer;
a determining element in said process arranged to determine, using a second software program stored in the memory element and provided by a third business entity, incremental revenue associated with a response to said retail offer, said response received by said interface element and said incremental revenue attributable to said use of said first software application to generate said retail offer; and,
a calculating element in said processor arranged to calculate, using the second software program, compensation to said second business entity for use of said software application by said first business entity, based at least partly on said incremental revenue.

19. The system of claim 18 wherein said generating element is arranged to generate a base portion of said retail offer and an upsell portion of said retail offer, wherein said determining element is arranged to track, using said processor and said second software application, an acceptance of said base portion and said upsell portion, and wherein said calculating element is arranged to calculate compensation based on said acceptance of said upsell portion.

20. The system of claim 18 wherein the first and second software applications are a single software application or the second and third business entities are a single business entity.
